(19) United States
(12) Patent Application Publication
(10) Pub. No.: US 2024/0354932 A1
(43) Pub. Date: Oct. 24, 2024

(54) TERMINAL AND ELECTRODE DEFECT DETECTION METHOD

(71) Applicant: LG ELECTRONICS INC., Seoul (KR)

(72) Inventors: Duho LEE, Seoul (KR); Mikiko ITO, Seoul (KR); Muyul PARK, Seoul (KR); Byungkee LEE, Seoul (KR); Youngjun JUNG, Seoul (KR)

(73) Assignee: LG ELECTRONICS INC., Seoul (KR)

(21) Appl. No.: 18/416,153

(22) Filed: Jan. 18, 2024

(30) Foreign Application Priority Data
Apr. 24, 2023 (KR) 10-2023-0053292

(51) Int. Cl. G06T 7/00; G01N 23/046; G06T 3/60

(52) U.S. Cl. CPC G06T 7/0008; G01N 23/046; G06T 3/60; G01N 2223/401; G01N 2223/408; G01N 2223/646; G06T 2207/10116; G06T 2207/20044; G06T 2207/20084

(57) ABSTRACT

A terminal can include a display and a processor configured to generate a reconstructed image based on a plurality of X-ray images of a battery, and rotate the reconstructed image by a predetermined angle to generate a tilting image. Also, the processor can generate an electrode detection image based on the tilting image, the electrode detection image including a positive electrode of the battery and a negative electrode of the battery in which the positive electrode and the negative electrode are separated from each other, and detect whether the battery is defective based on the electrode detection image.

### CROSS-REFERENCE TO RELATED APPLICATIONS

Pursuant to 35 U.S.C. § 119 (a), this application claims priority to Korean Patent Application No. 10-2023-0053292, filed in the Republic of Korea on Apr. 24, 2023, the entirety of which is hereby incorporated by reference herein into the present application.

### BACKGROUND

The present invention relates to a terminal, and more particularly, to a terminal for detecting defect in a secondary battery using an artificial intelligence model.

A secondary battery is a rechargeable battery that can be charged and discharged. Examples of the secondary battery include a lithium ion battery, a nickel-hydrogen battery, and a nickel cadmium battery.

Secondary battery, unlike general batteries that are disposable batteries, can be reused after being charged, so they have an advantage of being usable for a long period of time.

Due to fatal stability defects such as expansion and explosion due to misalignment (overhang) of the positive and negative electrodes of the secondary battery, total inspection is inevitable.

For this inspection, all inspections through computed tomography (CT) are in progress, but it has the disadvantage of requiring high cost and time, and rotation of the sample due to the nature of CT capturing.

In order to solve this problem, a laser sensor can be used to measure the profile of the positive electrode and negative electrode, but there is a problem in that an additional device such as a separate intake port is required due to a recognition error of the laser sensor itself.

Other solutions reconstruct an image of a secondary battery by combining a plurality of images.

However, the relative position between the detector and the X-ray source and the accurate position of the sample are desired, but the operation of the detector, the X-ray source, and the conveyor belt are all independent, so it is difficult to always maintain a constant position, there is a problem that arises distortion of the image.

### SUMMARY OF THE DISCLOSURE

A problem to be solved by the present disclosure is to facilitate electrode defect detection through a reconstructed image of an X-ray image.

A problem to be solved by the present disclosure is to overcome the problem of non-destructive inspection (high cost, low speed, rotation of an X-ray imaging device) of existing CT scans by using artificial intelligence.

A terminal according to an embodiment of the present disclosure can comprise a display and a processor is configured to generate a reconstructed image from a plurality of X-ray images of a secondary battery, obtain a tilting image obtained by rotating the reconstructed image by a predetermined angle, obtain an output image from the tilting image using an artificial neural network-based image quality improvement model learned through a supervised learning, obtain an electrode detection image in which a positive electrode and a negative electrode are separated from the output image using an artificial neural network-based electrode detection model learned through a supervised learning, perform post-processing on the obtained electrode detection image, and detect whether the secondary battery is defective based on a post-processing result.

An electrode defect detection method of a terminal according to an embodiment of the present disclosure can comprise generating a reconstruction image from a plurality of X-ray images of a secondary battery, obtaining a tilting image obtained by rotating the reconstructed image by a predetermined angle, obtaining an output image from the tilting image by using an artificial neural network-based image quality improvement model learned through a supervised learning, obtaining an electrode detection image in which an positive electrode and a negative electrode are separated from the output image using an artificial neural network-based electrode detection model learned through supervised learning, performing post-processing on the acquired electrode detection image and detecting whether the secondary battery is defective based on a post-processing result.

According to an embodiment of the present disclosure, it is possible to automate a process of inspecting defects of a secondary battery. Accordingly, the cost and effort of total inspection of the secondary battery can be greatly reduced.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a diagram for explaining a conventional tomosynthesis system.

FIG. 2 is a diagram for explaining an X-ray imaging apparatus according to an embodiment of the present disclosure.

FIG. 3 is a diagram for explaining a method for capturing X-ray images through on-off control of each of a plurality of X-ray sources according to an embodiment of the present disclosure.

FIGS. 4 and 5 are diagrams for explaining a method of capturing an X-ray image through an X-ray imaging apparatus according to an embodiment of the present disclosure.

FIG. 6 is a diagram for explaining an X-ray generator in which a plurality of X-ray sources are disposed in a two-dimensional (2D) array according to an embodiment of the present disclosure.

FIG. 7 is a diagram illustrating a plurality of pieces of projection data obtained by an X-ray imaging apparatus according to an embodiment of the present disclosure.

FIG. 8 is a block diagram illustrating an X-ray imaging apparatus according to an embodiment of the present disclosure.

FIG. 9 is a flowchart illustrating an X-ray image processing method according to an embodiment of the present disclosure.

FIG. 10 is a diagram for explaining a weighted projection method according to an embodiment of the present disclosure.

FIG. 11 is a diagram for comparing a tomographic image to which weighted projection is applied according to an embodiment of the present disclosure with a tomographic image reconstructed using a conventional technique.

FIG. 12 is a diagram for explaining a method for applying a bidirectional ramp filter according to an embodiment of the present disclosure.

FIG. 13 is a diagram for comparing a tomographic image to which a bidirectional ramp filter is applied according to an embodiment of the present disclosure with a tomographic image reconstructed using a conventional technique.

FIG. 14 is a diagram for explaining a method for generating a normalized tomographic image according to an embodiment of the present disclosure.

FIG. 15 is a diagram for explaining an iterative reconstruction method according to an embodiment of the present disclosure.

FIG. 16 is a block diagram for explaining the configuration of a terminal according to an embodiment of the present disclosure.

FIG. 17 is a flowchart for explaining a method of operating a terminal according to an embodiment of the present disclosure.

FIG. 18 is a diagram illustrating a process of performing CT imaging of a secondary battery by an X-ray imaging apparatus according to an embodiment of the present disclosure.

FIG. 19 is a diagram illustrating a reconstructed image according to an embodiment of the present disclosure.

FIG. 20 is a diagram illustrating a process of obtaining a tilting image by rotating a reconstructed image of a secondary battery according to an embodiment of the present disclosure.

FIG. 21 is a diagram for explaining a picture quality improvement model according to an embodiment of the present disclosure.

FIG. 22 is a diagram for explaining an electrode detection model according to an embodiment of the present disclosure.

FIGS. 23 and 24 are diagrams illustrating a process of detecting electrode defects of a secondary battery based on a post-processed image of an electrode detection image according to an embodiment of the present disclosure.

FIG. 25 is a diagram illustrating a process of generating an electrode pair length comparison graph according to an embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

The features of various embodiments of the present disclosure can be partially or entirely coupled to or combined with each other and can be interlocked and operated in technically various ways, and the embodiments can be carried out independently of or in association with each other.

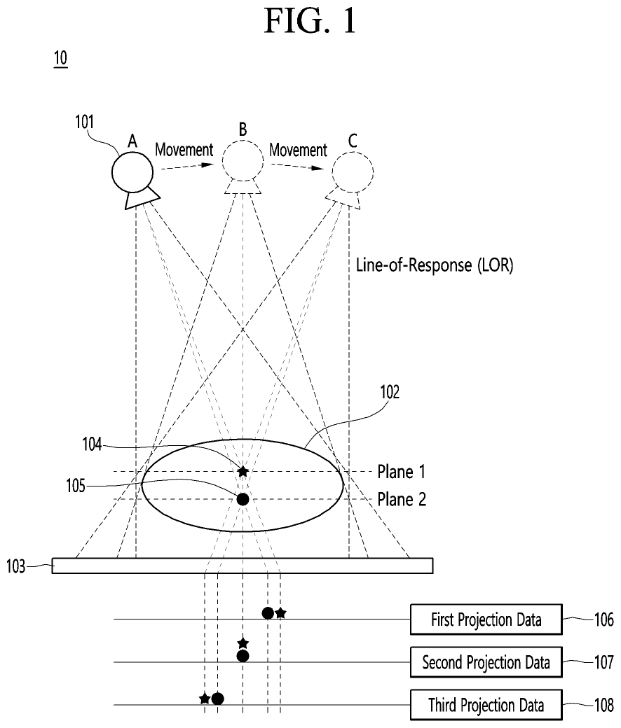

FIG. 1 is a diagram for explaining a conventional tomosynthesis system.

In the conventional tomosynthesis system 10, an X-ray generator 101 rotates and moves about 20 to 50 degrees with respect to a predetermined rotation axis and radiates X-rays to an object 102 to be captured. An X-ray detector 103 can generate an electrical signal corresponding to the radiation dose of transmitted X-rays.

On the other hand, when the X-ray generator 101 radiates X-rays to the object 102 to be captured while rotating and moving, the projected X-rays are detected by the X-ray detector 103 and a plurality of pieces of projection data 106, 107, 108 can be generated.

On the other hand, a first point 104 and a second point 105 can be projected by X-rays radiated by the X-ray generator 101 with respect to a first plane (Plane 1) and a second plane (Plane 2) of the object 102 to be captured, and can be mapped to the plurality of pieces of projection data 106, 107, and 108.

In this case, the first point 104 and the second point 105 mapped to the plurality of pieces of projection data 106, 107, and 108 can be differently mapped due to a change in an incident angle according to the rotational movement of the X-ray generator 101. Therefore, an operation of reconstructing a 2D or 3D X-ray tomographic image of the object 102 to be captured based on the plurality of pieces of projection data 106, 107, and 108 is additionally required.

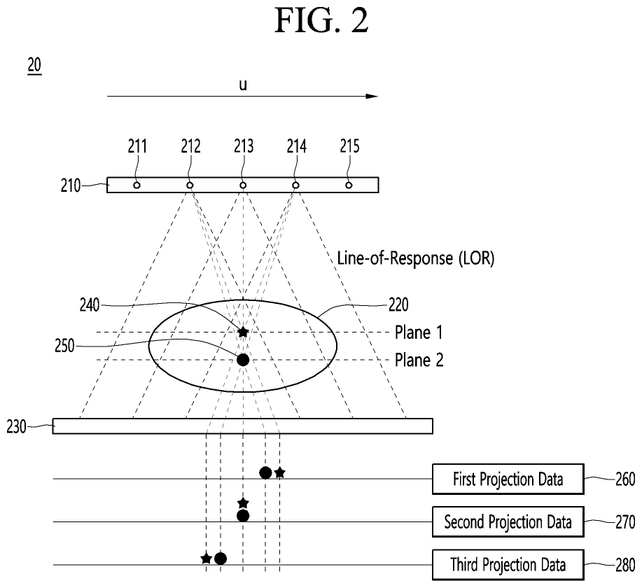

FIG. 2 is a diagram for explaining an X-ray imaging apparatus according to an embodiment of the present disclosure.

The X-ray imaging apparatus 20 includes an X-ray generator 210 in which a plurality of X-ray sources 211, 212, 213, 214, and 215 are disposed. The plurality of X-ray sources 211, 212, 213, 214, and 215 are turned on or off to radiate X-rays to the object 220 to be captured.

The X-ray detector 230 can generate an electrical signal corresponding to the radiation dose of transmitted X-rays. The X-ray sources can radiate X-rays in an electric field method.

On the other hand, the X-ray imaging apparatus 20 can have a horizontal movement method rather than the rotational movement of the conventional tomosynthesis system 10. For example, the X-ray imaging apparatus 20 can perform control so that X-rays are radiated in the order of the first X-ray source 212, the second X-ray source 213, and the third X-ray source 214.

On the other hand, a first point 240 and a second point 250 can be captured by being mapped to a plurality of pieces of projection data 260, 270, and 280 with respect to a first plane (Plane 1) and a second plane (Plane 2) of an object 102 to be captured.

In this case, the first point 240 and the second point 250 can be mapped to the plurality of pieces of projection data 260, 270, and 280 due to the horizontal movement through the on or off of the plurality of X-ray sources 211, 212, 213, 214, and 215 of the X-ray generator 210.

Therefore, an operation of reconstructing a 2D or 3D X-ray tomographic image of the object 220 to be captured based on the plurality of X-ray images 260, 270, and 280 is additionally required.

In this case, unlike the conventional tomosynthesis system 10 of FIG. 1, a tomographic image has to be generated by reflecting the characteristics of the horizontal on/off operations of the X-ray sources to reconstruct a plurality of pieces of projection data.

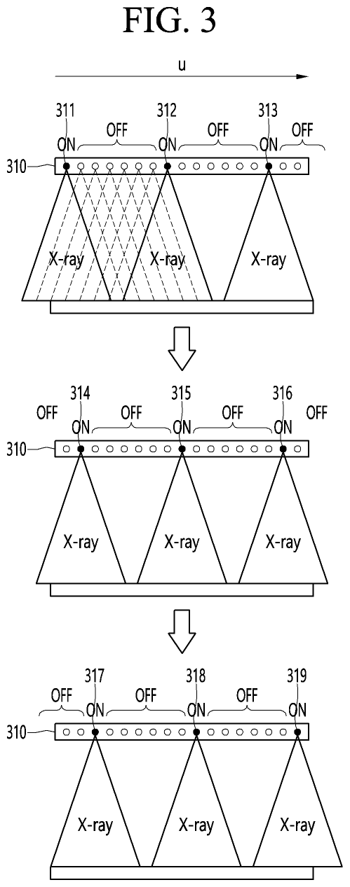

FIG. 3 is a diagram for explaining a method for capturing a plurality of X-ray images through on-off control of a plurality of X-ray sources according to an embodiment of the present disclosure.

The X-ray imaging apparatus 20 can control on or off of each of the plurality of X-ray sources included in the X-ray generator 210 to perform X-ray imaging on an object to be captured while horizontally moving in a first direction u.

The X-ray generator 210 operates at least one X-ray source for a predetermined time (e.g., several msec to several hundreds of msec) while maintaining the interval between the X-ray sources turned on so that the distributions of X-rays radiated on the X-ray detector 230 do not overlap. On the other hand, when the X-ray distributions overlap, the X-ray generator 210 can individually turn on or off the X-ray sources one by one.

The X-ray imaging apparatus 20 can perform control to turn on only some X-ray sources so that the X-rays radiated from the turned-on X-ray sources do not capture the object in an overlapping manner. For example, the X-ray imaging apparatus 20 can capture the object by turning on a first X-ray source 311, a second X-ray source 312, and a third X-ray source 313 among the plurality of X-ray sources included in the X-ray generator 210.

Thereafter, the X-ray imaging apparatus 20 can capture the object by turning on a fourth X-ray source 314, a fifth X-ray source 315, and a sixth X-ray source 316. In addition, the X-ray imaging apparatus 20 can capture the object by sequentially turning on a seventh X-ray source 317, an eighth X-ray source 318, and a ninth X-ray source 319.

On the other hand, the X-ray imaging apparatus 20 can simultaneously transmit a predetermined signal to the X-ray detector 230 when one or more X-ray sources are turned on, and can obtain and store projection data whenever each X-ray source is turned on.

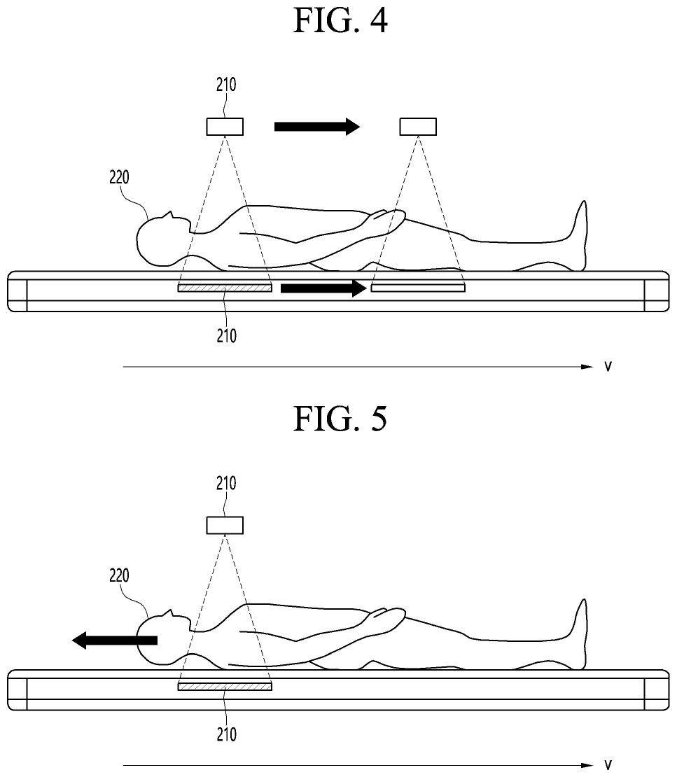

FIGS. 4 and 5 are diagrams for explaining a method of capturing an X-ray image through an X-ray imaging apparatus according to an embodiment of the present disclosure.

Referring to FIG. 4, in the X-ray imaging apparatus 20 according to an embodiment of the present disclosure, an X-ray generator 210 or an X-ray detector 230 can capture an X-ray image of an object 220 while horizontally moving in a second direction v.

Alternatively, referring to FIG. 5, in the X-ray imaging apparatus 20 according to an embodiment of the present disclosure, an X-ray image can be captured while the X-ray generator 210 or the X-ray detector 230 is fixed and the object 220 to be captured horizontally moves in the second direction v.

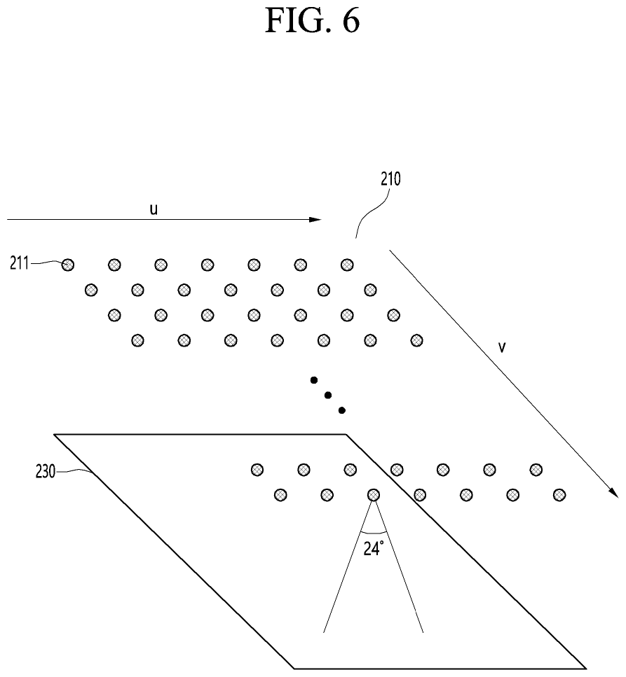

FIG. 6 is a diagram for explaining an X-ray generator in which a plurality of X-ray sources are disposed in a 2D array according to an embodiment of the present disclosure.

The plurality of X-ray sources 211 of the X-ray generator 210 can be arranged in a 2D array. The X-ray imaging apparatus 20 can capture an X-ray image by controlling each of the plurality of X-ray sources 211 to be turned on or off in the first direction u or the second direction v. Therefore, an object can be captured with the same effect as the case in which an X-ray generator in which a plurality of X-ray sources are disposed in a 1D line shape moves horizontally.

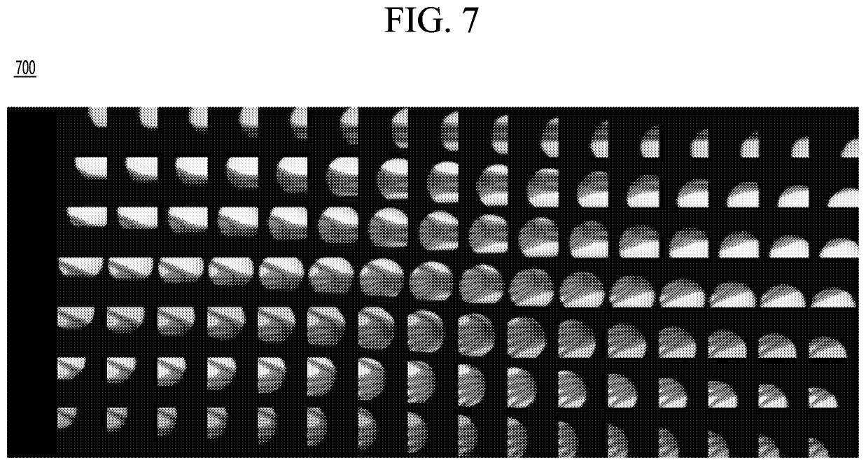

On the other hand, FIG. 7 is a diagram illustrating a plurality of pieces of projection data obtained by the X-ray imaging apparatus according to an embodiment of the present disclosure.

A plurality of pieces of projection data 700 can be an X-ray projection image projected when X-rays radiated while the plurality of X-ray sources of the X-ray generator 210 are sequentially turned on or off in the first direction u or the X-ray generator 210 moves horizontally in the second direction v are detected by the X-ray detector 230.

The X-ray imaging apparatus 20 can reconstruct a 2D or 3D X-ray image that is the tomographic image of the object to be captured based on the plurality of pieces of projection data 700.

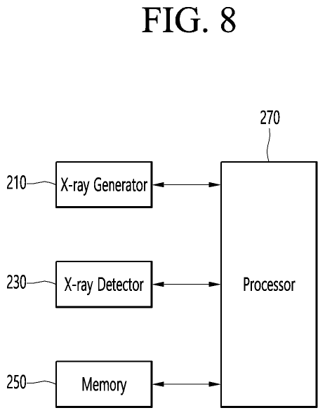

On the other hand, FIG. 8 is a block diagram illustrating an X-ray imaging apparatus according to an embodiment of the present disclosure.

The X-ray imaging apparatus 20 can include an X-ray generator 210, an X-ray detector 220, a memory 250, and a processor 270.

The X-ray generator 210 can include a plurality of X-ray sources. The plurality of X-ray sources can be arranged in a 1D line form or in a 2D array form.

The X-ray detector 230 can generate an electrical signal corresponding to the radiation dose of transmitted X-rays. The X-ray detector 230 can generate an electrical signal to generate projection data.

The memory 250 can store a program for processing and controlling each signal in the processor 270, and can store a signal-processed image, audio, or data signals. The memory 250 can store a plurality of pieces of projection data.

The processor 270 can control the movement of the X-ray generator 210 or the X-ray detector 230, or can control on or off of each of the plurality of X-ray sources of the X-ray generator 210.

In addition, the processor 270 can store the plurality of pieces of projection data generated by the X-ray detector 230 in the memory 250.

In addition, the processor 270 can reconstruct the plurality of pieces of projection data into a 2D or 3D X-ray image that is a tomographic image of an object to be captured. For example, the processor 270 can generate the 2D or 3D X-ray tomographic image by applying a predetermined reconstruction algorithm based on the plurality of pieces of projection data.

On the other hand, a representative example of the reconstruction algorithm is a filtered back projection (FBP) reconfiguration algorithm. However, when the FBP reconstruction algorithm used in the conventional tomosynthesis system 10 disclosed in FIG. 1 is used in the X-ray imaging apparatus 20 of FIG. 2, artifacts can occur in the reconstructed X-ray image. In the conventional tomosynthesis system 10, the X-ray generator rotates about a predetermined axis of rotation to obtain projection data, but the X-ray imaging apparatus 20 of FIG. 2 horizontally moves to obtain projection data. Thus, since X-rays are incident on a portion of the X-ray detector at a limited angle, only a portion of projection data is used to calculate one pixel value. Therefore, discontinuous linear image artifacts can appear in the reconstructed X-ray image.

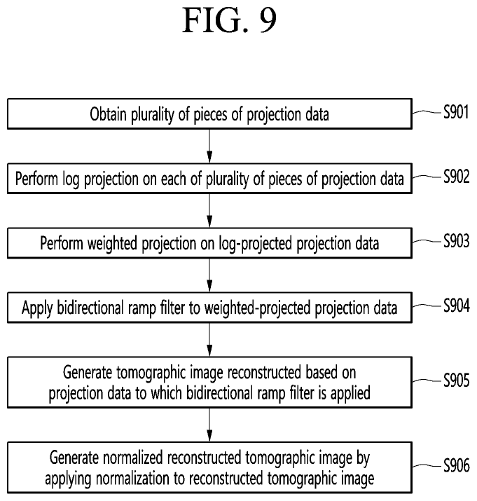

FIG. 9 is a flowchart illustrating an X-ray image processing method according to an embodiment of the present disclosure.

The processor 270 can obtain a plurality of pieces of projection data (S901). For example, the processor 270 can obtain a plurality of pieces of projection data generated by the X-ray detector 230 and stored in the memory 250.

The processor 270 can generate log-projected projection data by performing log projection on each of the plurality of pieces of projection data (S902). The log projection can be to change the exponential characteristics of the projection data reflected due to the exponential absorption of X-rays by the object 220 to a log scale so that the projection data has a linear value.

In addition, the processor 270 can generate weighted-projected projection data by performing weighted projection on the log-projected projection data (S903).

Referring to the plurality of pieces of projection data 700 of FIG. 7, each projection data has a boundary of an X-ray radiation area for a portion of the object to be captured. Accordingly, artifacts can occur near the boundary line when back-projected onto a field of view (FOV) area corresponding to the projection data. Therefore, the processor 270 can generate weighted-projected projection data by performing weighted projection on the log-projected projection data, thereby reducing artifacts occurring near the boundary line.

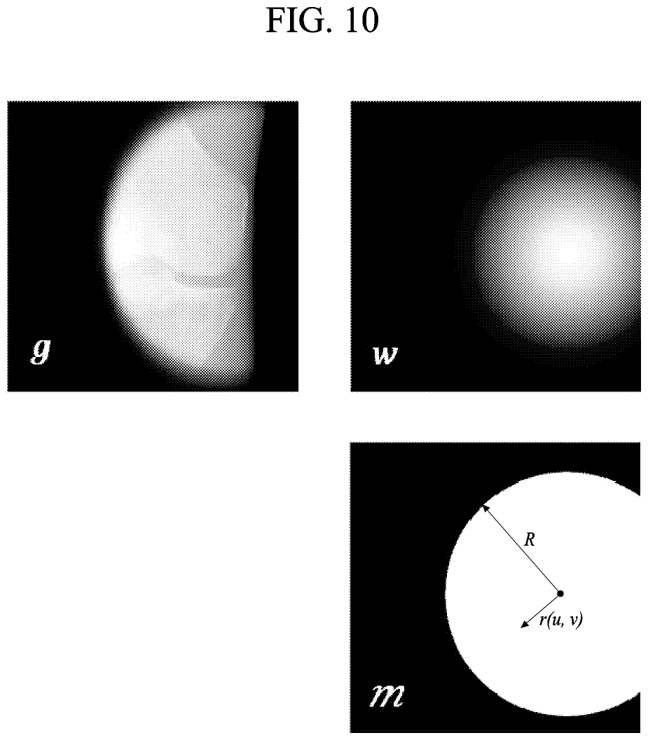

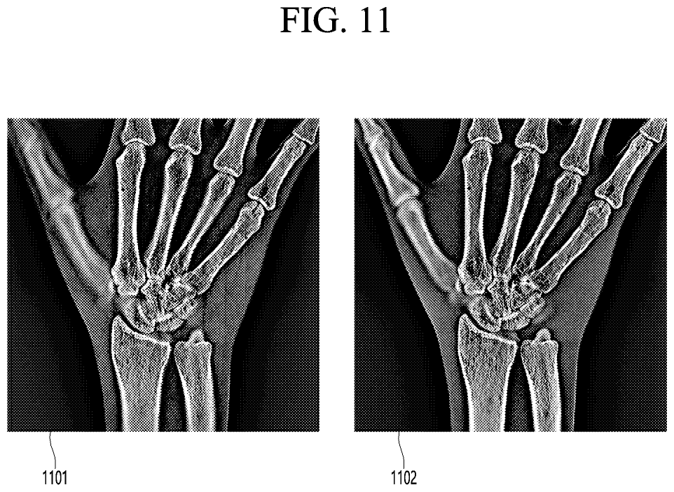

FIG. 10 is a diagram for explaining a weighted projection method according to an embodiment of the present disclosure.

The processor 270 can generate weighted-projected projection data (g_{w}) by applying a weight (w) to log-projected projection data (g). Equation 1 below can be applied to the weighted projection.

$$\\ \begin{matrix}{g}_{w} = g \cdot w & [ Equation 1 ]\end{matrix}$$

$$\\ w ( u , v ) = {cos}^{2} ( π r ( u , v ) / ( 2 * R ) )$$

u and v can be coordinates of the X-ray source.

FIG. 11 is a diagram for comparing a tomographic image to which weighted projection is applied according to an embodiment of the present disclosure with a tomographic image reconstructed using a conventional technique.

When a tomographic image 1101 reconstructed using the conventional technique is compared with a tomographic image 1102 to which weighted projection is applied, it can be seen that artifacts occurring near the boundary line are reduced.

On the other hand, the processor 270 can apply a bidirectional ramp filter to weighted-projected projection data g_{w} to generate projection data to which a bidirectional ramp filter is applied (S904).

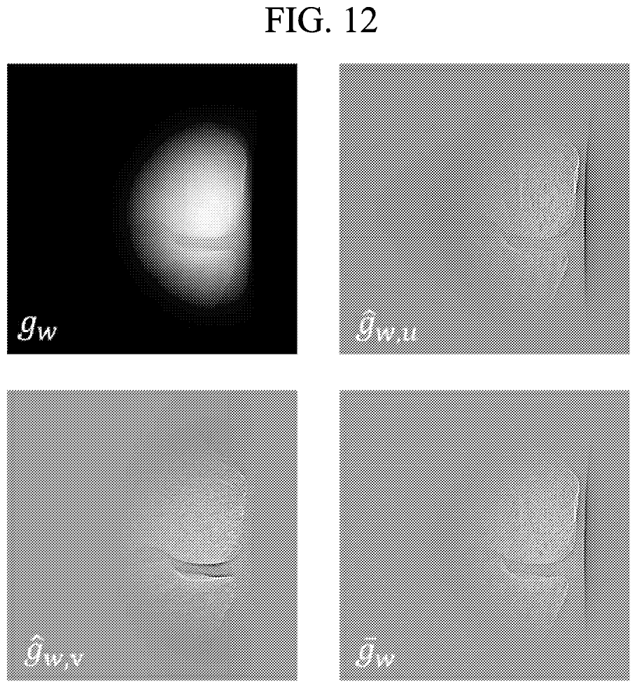

FIG. 12 is a diagram for explaining a method for applying a bidirectional ramp filter according to an embodiment of the present disclosure.

The ramp filter can be a filter for emphasizing a high frequency component in a predetermined direction in order to compensate for asymmetric appearance of a frequency component according to a direction of obtaining the projection data. Therefore, an effect of appearing an object more clearly can be exhibited.

The X-ray imaging apparatus 20 according to an embodiment of the present disclosure sequentially radiates X-rays to the object to be captured in each of the first direction (e.g., u direction) and the second direction (e.g., v direction) to obtain projection data. Since the image is captured by horizontal movement in the first direction u or the second direction v, an area in which the object to be captured disappears is generated in each of the plurality of pieces of projection data.

For example, when the X-ray generator 210 includes a plurality of X-ray sources disposed in a 1D line form, the plurality of X-ray sources are sequentially turned on and radiate X-rays to the object to be captured in the first direction. In addition, the X-ray generator 210 can move in the second direction to capture an image.

Accordingly, when a 1D ramp filter is applied in only one direction to each of a plurality of pieces of projection data, objects in the projection data can be blurred in only one direction, resulting in an asymmetric shape.

Therefore, the processor 270 can apply the ramp filter in both directions (the first direction and the second direction).

Referring to FIG. 12, the processor 270 can obtain projection data (ĝ_{w,u}) to which the ramp filter is applied to weighted-projected projection data (g_{w}) in the first direction u. In addition, the processor 270 can obtain projection data (ĝ_{w,v}) to which the ramp filter is applied to weighted-projected projection data (g_{w}) in the second direction v. In addition, the processor 270 can obtain projection data (g̅_{w}) to which the ramp filter is applied to weighted-projected projection data (g_{w}) in both directions. The following equation can be applied to the projection data (g̅_{w}) to which the ramp filter is applied in both directions.

$$\\ \begin{matrix}{\overline{g}}_{w} = {w}_{u} {\hat{g}}_{w , u} + ( 1 - {w}_{u} ) {\hat{g}}_{w , v} & [ Equation 2 ]\end{matrix}$$

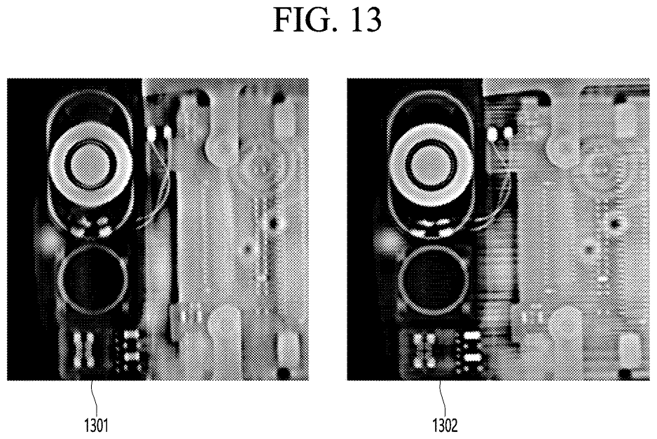

FIG. 13 is a diagram for comparing a tomographic image to which a bidirectional ramp filter is applied according to an embodiment of the present disclosure with a tomographic image reconstructed using a conventional technique.

When the tomographic image 1301 reconstructed using the conventional technique is compared with the tomographic image 1302 to which the bidirectional ramp filter is applied, it can be seen that the phenomenon in which objects are blurred in only one direction and thus an asymmetric shape occurs is reduced.

On the other hand, the processor 270 can generate a reconstructed tomographic image based on each of the projection data to which the bidirectional ramp filter is applied (S905). In this case, a reconstruction image step in a general FBP algorithm can be applied.

In addition, the processor 270 can generate a normalized reconstructed tomographic image by applying normalization to the reconstructed tomographic image (S906).

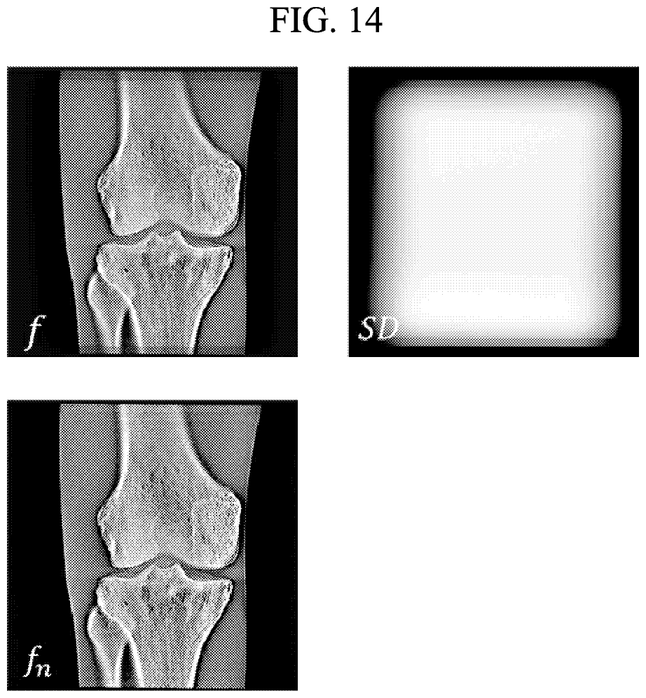

FIG. 14 is a diagram for explaining a method for generating a normalized tomographic image according to an embodiment of the present disclosure.

The plurality of pieces of projection data are data captured by horizontal movement of a plurality of X-ray sources in a first direction or a second direction. Accordingly, more X-rays can be radiated from the edge of the object to the center of the object to be captured, and more pixels overlap the projection data toward the center of the object to be captured.

Accordingly, the processor 270 can generate a sampling density (SD) map by reconstructing weights used in weighted projection, and divide the reconstructed tomographic image (f) to generate a normalized reconstructed tomographic image (fₙ). The following equation can be applied to the reconstructed tomographic image (f), the SD map, and the normalized reconstructed tomographic image (fₙ).

$$\\ \begin{matrix}f ( \vec{x} ) = {\sum }_{i = 1}^{N} {\overline{g}}_{w , i} ( \vec{u} ( i , \vec{x} ) ) & [ Equation 3 ]\end{matrix}$$

$$\\ SD = {\sum }_{i = 1}^{N} w ( \vec{u} ( i , \vec{x} ) )$$

$$\\ N : total number of sources$$

$$\\ {f}_{n} = f / SD$$

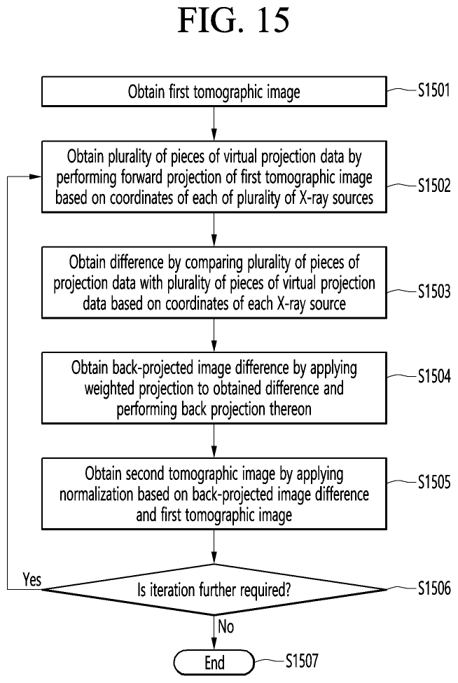

FIG. 15 is a diagram for explaining an iterative reconstruction method according to an embodiment of the present disclosure.

On the other hand, the processor 270 can iteratively perform the reconstruction process again after initially obtaining the normalized reconstructed tomographic image. In this case, the processor 270 can use a Maximum Likelihood-Expectation Maximization (ML-EM) algorithm or the like.

The processor 270 can repeat the iterative reconstruction process with respect to the normalized reconstructed tomographic image until an iteration criterion is satisfied. The iteration criterion can be set to a predetermined number of iterations.

The processor 270 can obtain the initially generated normalized reconstructed tomographic image as a first tomographic image (S1501).

The processor 270 can obtain a plurality of pieces of virtual projection data by performing forward projection of the first tomographic image based on the coordinates (u, v) of each of the plurality of X-ray sources (S1502).

The processor 270 can obtain a difference or a ratio by comparing the plurality of pieces of projection data obtained by radiating X-rays to the object to be captured with the plurality of pieces of virtual projection data, based on the coordinates of each X-ray source (S1503).

The processor 270 can obtain a back-projected image difference or ratio (back-project ratio) by applying weighted projection to the obtained difference or ratio (S1504).

In addition, the processor 270 can obtain a second tomographic image by applying normalization based on the back-projected image difference or ratio and the first tomographic image (S1505).

In addition, the processor 270 can determine whether iteration is further required (S1506). For example, when a predetermined number of iterations is satisfied, the processor 270 can determine that further iterations are not necessary and can end the iterative reconstruction (S1507). In addition, for example, when the predetermined number of iterations is not satisfied, the processor 270 can determine that iterations are further necessary and can perform a reconstruction process again on the second tomographic image (S1502).

On the other hand, an (n+1)-th tomographic image that has undergone the iterative reconstruction process for an n-th tomographic image can satisfy the following equation.

$$\\ \begin{matrix}{f}_{j}^{{}_{} ( n + 1 )} = \frac{{f}_{j}^{{}_{} ( n )}}{{\sum }_{i} {h}_{ij}} {\sum }_{i} {h}_{ij} \frac{{g}_{i}}{{\sum }_{k} {h}_{ik} \hat{f} {}_{k}^{{}_{} ( n )}} & [ Equation 4 ]\end{matrix}$$

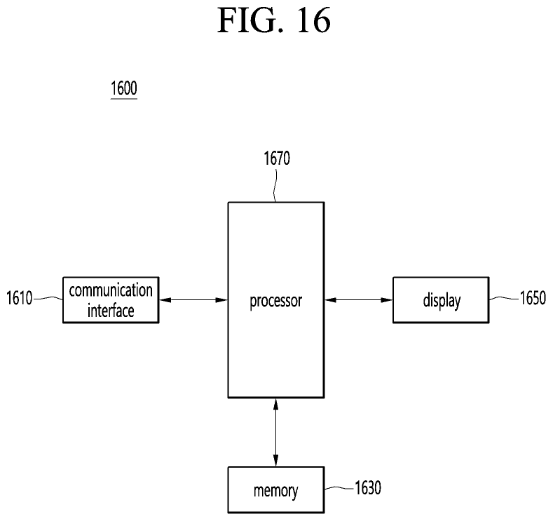

FIG. 16 is a block diagram for explaining the configuration of a terminal according to an embodiment of the present disclosure.

Referring to FIG. 16, a terminal 1600 can include a communication interface 1610, a memory 1630, a display 1650, and a processor 1670.

The terminal 1600 can be an electronic device such as a PC, laptop computer, smart phone, or smart pad.

The communication interface 1610 can communicate with an external device through wired or wireless communication.

The communication interface 1610 can access a predetermined web page through a connected network or another network linked to the connected network. That is, by accessing a predetermined web page through a network, data can be transmitted or received with a corresponding server.

The communication interface 1610 can perform short range communication with an external device.

The communication interface 1610 can support short-range communication using at least one of BLUETOOTH™, Radio Frequency Identification (RFID), Infrared Data Association (IrDA), Ultra Wideband (UWB), ZIGBEE, Near Field Communication (NFC), Wireless-Fi (Wi-Fi) Local communication Wi-Fi Direct, Wi-Fi Direct, and Wireless Universal Serial Bus (USB) technology.

The communication interface 1610 can receive a 2D image or a 3D image from an external device. The external device can be the X-ray imaging device 20 or a server.

The communication interface 1610 can receive an X-ray image from the X-ray imaging apparatus 20.

The memory 1630 can store data supporting various functions.

The memory 1630 can store input data, learning data, a learning model, a learning history, and the like.

The display 1650 can display information processed by the terminal 1600.

The display 1650 can display an image. The display 1650 can include a 3D image or a 2D image generated based on the 3D image.

The display 1650 can implement a touch screen by forming a mutual layer structure or integrally with the touch sensor.

The touch screen functions as a user input unit that provides an input interface between the terminal 1600 and the user, and can provide an output interface between the terminal 1600 and the user.

The processor 1670 can control overall operations of the terminal 1600.

The processor 1670 can obtain a reconstruction image of the secondary battery from a plurality of X-ray images of the secondary battery. The reconstructed image can be a 3D image.

The processor 1670 can obtain a tilting image tilted by a predetermined angle from the reconstructed image.

The processor 1670 can obtain an output image from the tilting image using an image quality enhancement model.

The processor 1670 can obtain an electrode detection image from the output image using the electrode detection model.

The processor 1670 can perform post-processing on the electrode detection image.

The processor 1670 can detect whether or not the electrode is defective based on the post-processed image.

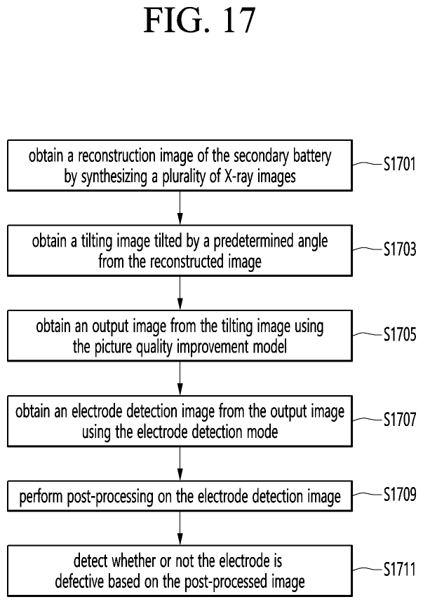

FIG. 17 is a flowchart for explaining a method of operating a terminal according to an embodiment of the present disclosure.

The processor 1670 of the terminal 1600 can obtain a reconstruction image of the secondary battery from a plurality of X-ray images of the secondary battery (S1701).

The processor 1670 can generate a reconstructed image from one or more X-ray images or a plurality of X-ray images.

The processor 1670 can receive one or more X-ray images from the X-ray imaging apparatus 20.

In an embodiment, the reconstructed image can be a reconstructed tomography image obtained according to the embodiment of FIG. 9.

In another embodiment, the reconstructed image can be a second tomographic image obtained according to the embodiment of FIG. 15.

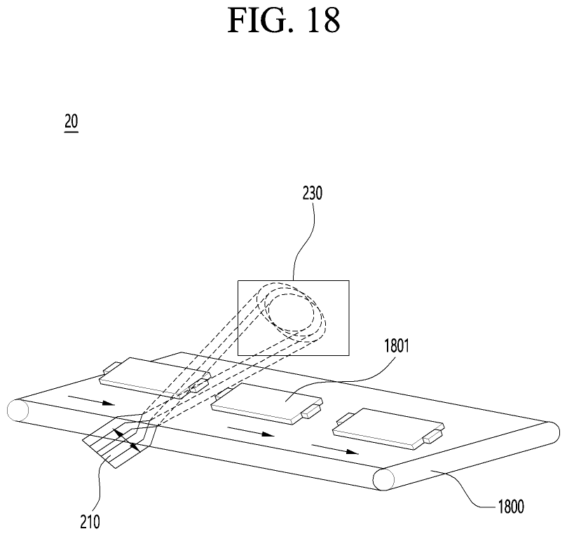

FIG. 18 is diagrams illustrating a process of performing CT imaging of a secondary battery by an X-ray imaging apparatus according to an embodiment of the present disclosure.

Referring to FIG. 18, a sample 1801 (a secondary battery) is placed on a conveyor belt 1800.

The X-ray imaging apparatus 20 can include an X-ray generator 210 and an X-ray detector 230.

The X-ray imaging device 20 can be the device according to the embodiment of FIG. 2.

The X-ray generator 210 can include a plurality of X-ray sources. A plurality of X-ray sources can sequentially emit X-ray.

Each of the plurality of X-ray source can emit X-rays through a horizontal movement method by turning on or off.

The embodiments of FIGS. 2 and 3 can be applied to a method of obtaining an X-ray image through the X-ray imaging apparatus 20.

FIG. 18 shows results obtained by X-ray images 1811, 1813, and 1815 of the specimen 1801 through the X-ray detector 230.

The processor 1670 of the terminal 1600 can obtain a reconstructed image based on the plurality of X-ray images 1811, 1813, and 1815.

In an embodiment, the reconstructed image can be a reconstructed tomography image generated according to the embodiment of FIG. 9.

In another embodiment, the reconstructed image can be a tomography image generated according to the embodiment of FIG. 15.

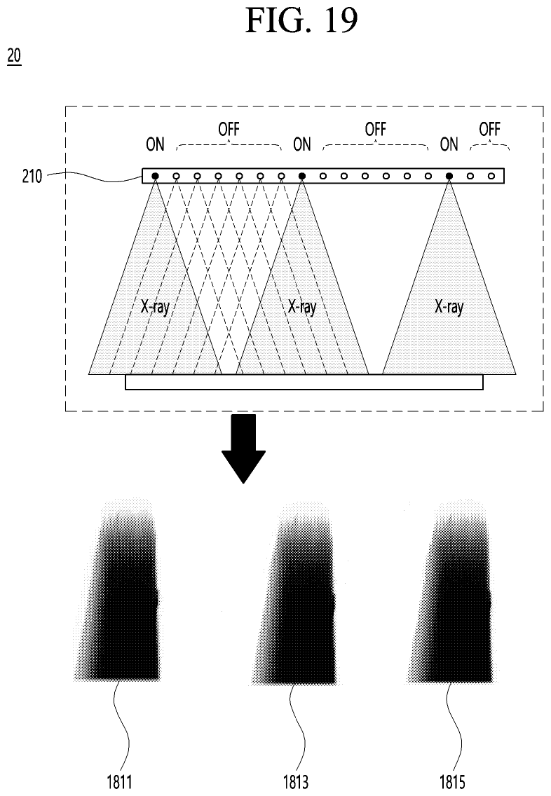

FIG. 19 is a diagram illustrating a reconstructed image according to an embodiment of the present disclosure.

Referring to FIG. 19, a direction of reconstruction of an image can be a z-axis direction. The reconstructed image 1900 can be a vertical image of the secondary battery 1801 in the z-axis direction.

Again, FIG. 17 will be described.

The processor 1670 of the terminal 1600 can obtain a tilting image tilted by a certain angle from the reconstructed image (S1703).

It is necessary to rotate the reconstructed image 1900 of the secondary electrons in order to measure the length of the actual electrode, which is a standard for detecting defects in the secondary battery electrode.

The processor 1670 can rotate the reconstructed image by a predetermined angle to measure the length of the actual electrode of the secondary battery.

The predetermined angle can be 45 degrees, but this is only an example.

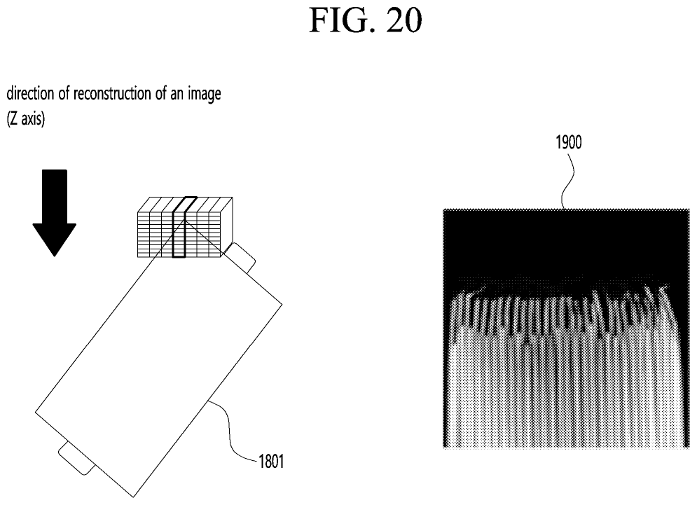

FIG. 20 is a diagram illustrating a process of obtaining a tilting image by rotating a reconstructed image of a secondary battery according to an embodiment of the present disclosure.

Referring to FIG. 20, the processor 1670 can tilt the reconstructed image 1900 of FIG. 19 by a predetermined angle to measure the electrode length.

The certain angle can be −45 degrees, but this is only an example.

The processor 1670 can obtain the tilting image 2000 by tilting the reconstructed image 1900 by a predetermined angle.

However, during the tilting process, the quality of the tilting image 2000 can deteriorate compared to that of the reconstructed image 1900.

Again, FIG. 17 will be described.

The processor 1670 of the terminal 1600 can obtain an output image from the tilting image using the picture quality improvement model (S1705).

In one embodiment, the image quality improvement model can be a model based on an artificial neural network trained using deep learning or machine learning.

The processor 1670 can receive an image quality improvement model from an AI server and store the received image quality improvement model in the memory 1630.

The picture quality improvement model can be a model learned through supervised learning.

The picture quality improvement model can be a model for inferring an output image with improved picture quality from an input tilting image using an artificial neural network.

A training data set for training of an image quality improvement model can include a 3D image for learning and a CT image labeled with the 3D image for learning.

The quality improvement model can be trained to minimize a loss function that minimizes a difference between a 3D image for training and a CT image serving as labeling data.

That is, model parameters of the picture quality enhancement model can be determined such that the loss function is minimized.

A Convolution Neural Network (CNN) can be used for supervised learning of an image quality improvement model.

The terminal 1600 can receive the trained picture quality improvement model from the AI server.

In another example, the terminal 1600 can directly learn an image quality improvement model through the processor 1670 or a learning processor.

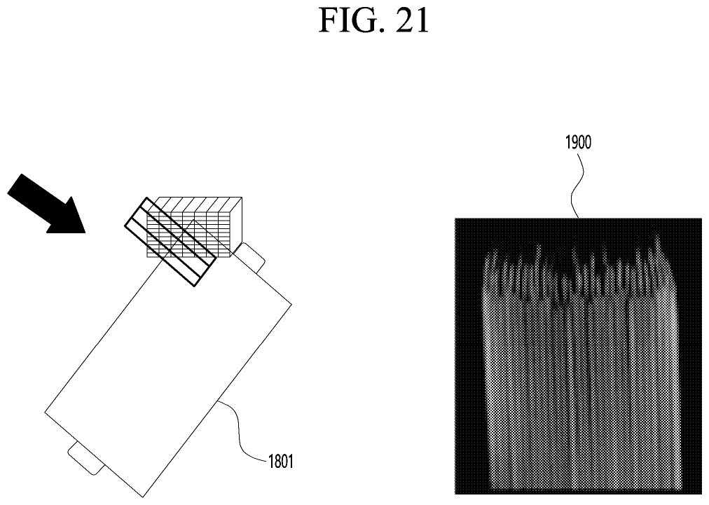

FIG. 21 is a diagram for explaining a picture quality improvement model according to an embodiment of the present disclosure.

Referring to FIG. 21, an artificial neural network-based image quality improvement model 2100 is illustrated.

A training data set for supervised learning of the quality improvement model 2100 can include a 3D image 2101 for learning and a CT image 2103 labeled on the 3D image 2101 for learning.

The image quality improvement model 2100 can be supervised and learned so that a loss function representing a difference between the training 3D image 2101 and the CT image 2103 is minimized.

After the learning of the picture quality improvement model 2100 is completed, when the tilting image is input to the picture quality improvement model 2100, an output image with improved picture quality can be output.

Again, FIG. 17 will be described.

The processor 1670 of the terminal 1600 can obtain an electrode detection image from the output image using the electrode detection model (S1707).

The electrode detection model can be a model based on an artificial neural network supervised using deep learning or machine learning.

The terminal 1600 can receive the electrode detection model from the AI server, or the processor 1670 of the terminal 1600 can learn the electrode detection model by itself.

The electrode detection model can be stored in memory 1630.

The electrode detection model can be a model for inferring an electrode detection image in which a positive electrode and a negative electrode are separated from an output image reflecting an image quality improvement result using an artificial neural network.

The electrode detection image can be an image in which the positive electrode and the negative electrode of the secondary battery are separated.

A training data set for supervised learning of the electrode detection model can include a quality improvement image for training and a labeling image labeled with the quality improvement image for training.

The electrode detection model can be supervised and learned such that a loss function representing a difference between a quality improvement image for training and a labeling image is minimized. That is, model parameters of the electrode detection model can be determined such that the loss function is minimized.

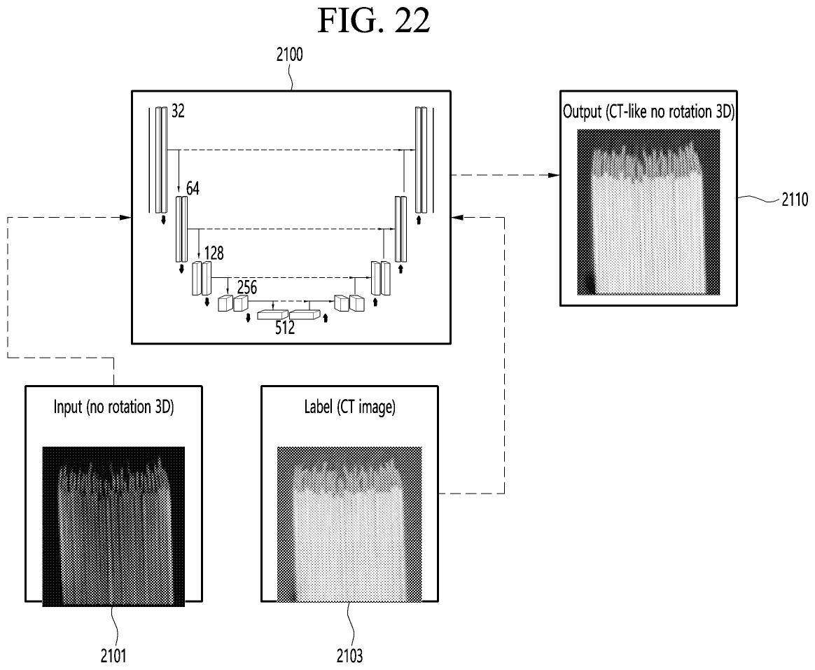

FIG. 22 is a diagram for explaining an electrode detection model according to an embodiment of the present disclosure.

Referring to FIG. 22, an artificial neural network based electrode detection model 2200 is shown.

A training data set used for supervised learning of the electrode detection model 2200 can include an electrode image 2201 for learning and a labeling electrode image 2203 labeled with the electrode image 2203 for learning.

Pre-processing can be performed on the learning electrode image 2201 in advance.

Pre-processing can include a ROI crop step and contrast normalization.

The electrode detection model 2200 can be trained to minimize a loss function representing a difference between the training electrode image 2201 and the labeling electrode image 2203.

Model parameters of the electrode detection model 2200 can be determined such that the loss function is minimized.

The electrode detection model 2200 can output an electrode detection image 2210 in which the positive electrode 2211 and negative electrode 2213 are separated from the input electrode image.

Aluminum (Al) can be used as the positive electrode 2211 and copper (Cu) can be used as the negative electrode 2213, but this is only an example.

The electrode detection model 2200 can be trained using a Faster R-CNN (Regions with Convolution Neural Networks) algorithm.

Faster R-CNN (Regions with Convolution Neural Networks) algorithm extracts a feature map from the learning electrode image 2201 through CCN, calculates a region of interest (RoI) from the feature map, and performs RoI pooling. and a classification step of classifying electrodes according to performance results.

Again, FIG. 17 will be described.

The processor 1670 of the terminal 1600 can perform post-processing on the electrode detection image (S1709).

Post-processing can include skeletonization of the electrode detection image 2210.

Skeletonization can be a process of extracting center points (pixels) of each electrode included in the electrode detection image 2210.

The distance between two adjacent center points can be the same.

The processor 1670 of the terminal 1600 can detect whether or not the electrode is defective based on the post-processed image (S1711).

The processor 1670 can calculate a difference in the number of pixels between the positive electrode and the negative electrode from the post-processing image, and calculate a length difference (or overhang) between the positive electrode and the negative electrode based on the calculated difference in the number of pixels.

The processor 1670 can determine that the electrode of the secondary battery is normal when the calculated length difference is less than or equal to a predetermined value, and determine that the electrode of the corresponding secondary battery is defective when the calculated length difference exceeds a predetermined value. there is.

When the secondary battery electrode is determined to be defective, the processor 1670 can re-measure the length between the positive electrode and the negative electrode of the secondary battery.

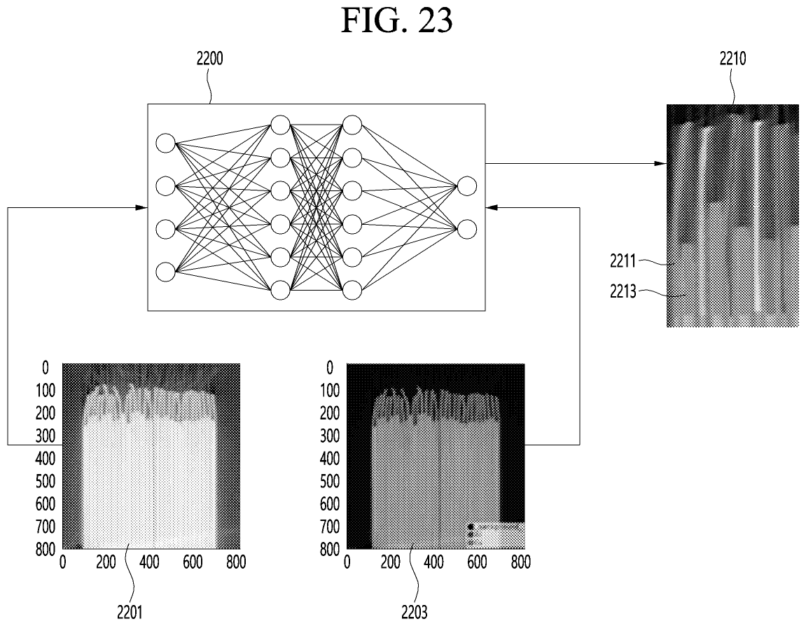

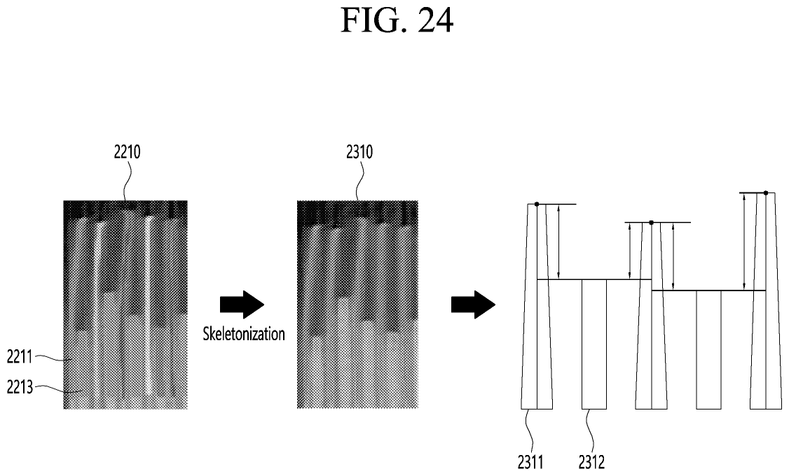

FIGS. 23 and 24 are diagrams illustrating a process of detecting electrode defects of a secondary battery based on a post-processed image of an electrode detection image according to an embodiment of the present disclosure.

Referring to FIG. 23, an electrode detection image 2210 output through an electrode detection model is shown.

The processor 1670 can perform a skeletonization operation as a post-processing operation on the electrode detection image 2210.

The processor 1670 extracts a center line passing through each of the positive electrode 2211 and negative electrode 2213 included in the electrode detection image 2210 and classifies the extracted center line into a plurality of center points (pixels) having regular interval. This process can be a skeletonization operation.

A plurality of center points can be located on the center line.

The processor 1670 can obtain a positive electrode image 2311 in which the positive electrode 2211 has been skeletonized and a negative electrode image 2313 in which the negative electrode 2213 has been skeletonized.

The processor 1670 can calculate the number of pixels constituting each of the positive image 2311 and the negative image 2313 and calculate a difference between the number of pixels based on the calculation result.

The distance between adjacent pixels can be the same.

The processor 1670 can calculate a length difference between a positive electrode and a negative electrode based on the difference in the number of pixels.

The processor 1670 can detect that the electrode pair of the secondary battery is normal when the length difference between the positive electrode and the negative electrode is less than or equal to a predetermined value, and can detect that the electrode pair of the corresponding secondary battery is defective when the length difference exceeds a predetermined value.

Referring to FIG. 24, an electrode detection image 2410 output through an electrode detection model 2200 is shown. The electrode detection image 2410 can include a plurality of electrode pairs.

The processor 1670 can acquire a post-processed image through post-processing of the electrode detection image 2410 and calculate a length difference between each electrode pair through the post-processed image.

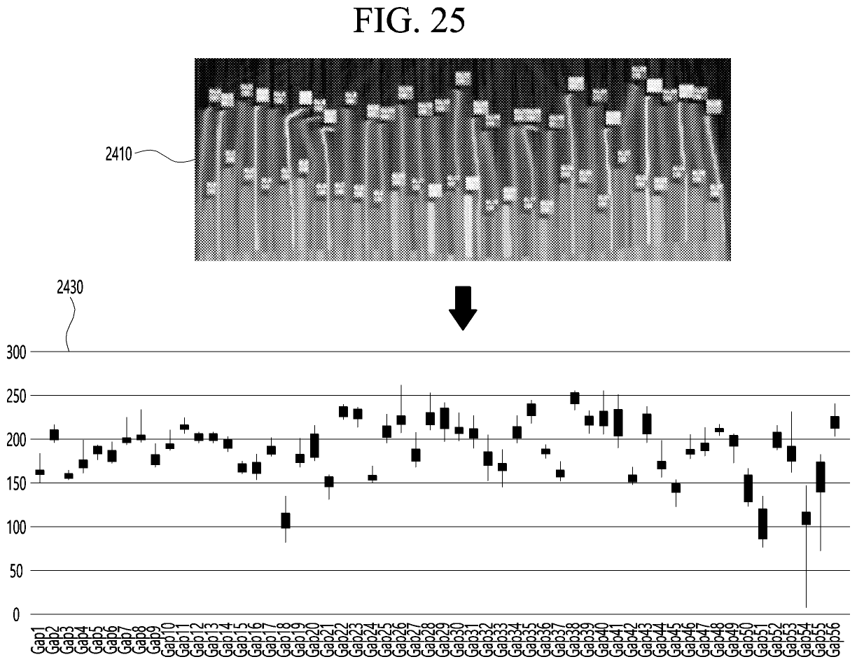

Referring to FIG. 25, the processor 1670 can obtain an electrode pair length comparison graph 2430 indicating a length difference between each of a plurality of electrode pairs.

The processor 1670 can detect whether a specific electrode pair is defective through the electrode pair length comparison graph 2430.

As described above, according to an embodiment of the present disclosure, it is possible to reduce total inspection cost by automatically determining whether defects are detected in an electrode from a reconstructed image based on an X-ray image.

Meanwhile, the processor 1670 can display, on the display 1650, information on whether or not the secondary battery is defective, determined based on the length difference between the positive electrode and the electrode.

After the secondary battery passes through the conveyor belt, the processor 1670 can display information on whether or not the secondary battery is defective on the display 1650.

According to an embodiment of the present invention, the above-described method can be implemented as a processor-readable code in a medium on which a program is recorded.

Examples of media readable by the processor include ROM, RAM, CD-ROM, magnetic tape, floppy disk, optical data storage, and the like.

The above description is merely illustrative of the technical idea of the present disclosure, and various modifications and changes can be made thereto by those skilled in the art without departing from the essential characteristics of the present disclosure.

Therefore, the embodiments of the present disclosure are not intended to limit the technical spirit of the present disclosure but to describe the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

What is claimed is:

1. A terminal comprising:
a display; and
a processor is configured to:
generate a reconstructed image based on a plurality of X-ray images of a battery,
rotate the reconstructed image by a predetermined angle to generate a tilting image,
input the tilting image to an artificial neural network-based image quality improvement model and generate an output image based on an output of the artificial neural network-based image quality improvement model,
input the output image to an artificial neural network-based electrode detection model and generate an electrode detection image based on an output of the artificial neural network-based electrode detection model, the electrode detection image including a positive electrode of the battery and a negative electrode of the battery in which the positive electrode and the negative electrode are separated from each other,
perform post-processing on the electrode detection image to generate a post-processing result, and
detect whether the battery is defective based on the post-processing result.

2. The terminal of claim 1, wherein the battery is a secondary battery or a rechargeable battery.

3. The terminal of claim 1, wherein the artificial neural network-based image quality improvement model is learned through a supervised learning, and
wherein the artificial neural network-based electrode detection model is learned through a supervised learning.

4. The terminal of claim 1, wherein the processor is further configured to perform a skeletonization operation on the positive electrode and the negative electrode included in the electrode detection image.

5. The terminal of claim 4, wherein the skeletonization operation includes extracting pixels located on a center line of each of the positive electrode and the negative electrode, and
wherein the processor is further configured to:
calculate a difference between a number of pixels of the positive electrode and a number of pixels of the negative electrode,
calculate a length difference between the positive electrode and the negative electrode based on the length difference,
in response to the length difference being less than a predetermined value, determine that the battery is non-defective, and
in response to the length difference exceeding the predetermined value, determine that the battery is defective.

6. The terminal of claim 1, wherein the processor is further configured to display a detection result of whether or not the battery is defective on the display.

7. The terminal of claim 1, further comprising:
a memory configured to store the artificial neural network-based electrode detection model, and store a training data set used for supervised learning of the artificial neural network-based electrode detection model, the training data set including the output image for training and a labeling image labeled based on the output image.

8. The terminal of claim 1, further comprising:
a memory configured to store the artificial neural network-based image quality improvement model, and store a training data set used for supervised learning of the artificial neural network-based image quality improvement model, the training data set including the tilting image for training and a labeling image labeled based on the tilting image.

9. The terminal of claim 1, further comprising:
a communication interface configured to receive the plurality of X-ray images from an X-ray imaging device.

10. A method of controlling a terminal for defect detection, the method comprising:
generating, by a processor in the terminal, a reconstructed image based on a plurality of X-ray images of a battery;
rotating, by the processor, the reconstructed image by a predetermined angle to generate a tilting image;
inputting, by the processor, the tilting image to an artificial neural network-based image quality improvement model and generating an output image based on an output of the artificial neural network-based image quality improvement model;
inputting, by the processor, the output image to an artificial neural network-based electrode detection model and generating an electrode detection image based on an output of the artificial neural network-based electrode detection model, the electrode detection image including a positive electrode of the battery and a negative electrode of the battery in which the positive electrode and the negative electrode are separated from each other;
performing, by the processor, post-processing on the electrode detection image to generate a post-processing result; and
detecting, by the processor, whether the battery is defective based on the post-processing result.

11. The method of claim 10, wherein the battery is a secondary battery or a rechargeable battery.

12. The method of claim 10, wherein the artificial neural network-based image quality improvement model is learned through a supervised learning, and
wherein the artificial neural network-based electrode detection model is learned through a supervised learning.

13. The method of claim 10, wherein the post-processing includes:
performing a skeletonization operation on the positive electrode and the negative electrode included in the electrode detection image.

14. The method of claim 13, wherein the skeletonization operation includes extracting pixels located on a center line of each of the positive electrode and the negative electrode, and
wherein the detecting includes:
calculating a difference between a number of pixels of the positive electrode and a number of pixels of the negative electrode,
calculating a length difference between the positive electrode and the negative electrode based on the length difference,
in response to the length difference being less than a predetermined value, determining that the battery is non-defective, and
in response to the length difference exceeding the predetermined value, determining that the battery is defective.

15. The method of claim 10, further comprising displaying, on a display of the terminal, a detection result indicating whether or not the battery is defective.

16. The method of claim 10, further comprising storing the artificial neural network-based electrode detection model, and storing a training data set used for supervised learning of the artificial neural network-based electrode detection model, the training data set including the output image for training and a labeling image labeled based on the output image.

17. The method of claim 10, further comprising storing the artificial neural network-based image quality improvement model, and store a training data set used for supervised learning of the artificial neural network-based image quality improvement model, the training data set including the tilting image for training and a labeling image labeled based on the tilting image.

18. The method of claim 10, further comprising receiving, by the processor, the plurality of X-ray images from an X-ray imaging device.

19. A terminal comprising:
a display; and
a processor is configured to:
receive a plurality of X-ray images of a battery,
generate a reconstructed image based on the plurality of X-ray images,
rotate the reconstructed image by a predetermined angle to generate a tilting image,
generate an electrode detection image based on the tilting image, the electrode detection image including a positive electrode of the battery and a negative electrode of the battery in which the positive electrode and the negative electrode are separated from each other, and
detect whether the battery is defective based on the electrode detection image.

20. The terminal of claim 19, wherein the processor is further configured to:
perform a skeletonization operation on the positive electrode and the negative electrode included in the electrode detection image by extracting pixels located on a center line of each of the positive electrode and the negative electrode,
calculate a difference between a number of pixels of the positive electrode and a number of pixels of the negative electrode,
calculate a length difference between the positive electrode and the negative electrode based on the length difference,
in response to the length difference being less than a predetermined value, determine that the battery is non-defective, and
in response to the length difference exceeding the predetermined value, determine that the battery is defective.
